(19) United States
(12) Patent Application Publication
(10) Pub. No.: US 2012/0269495 A1
(43) Pub. Date: Oct. 25, 2012

(54) INFORMATION PROCESSING APPARATUS, INFORMATION PROCESSING METHOD, AND COMPUTER-READABLE RECORDING MEDIUM

(76) Inventor: FUMITOSHI MIZUTANI, Ome-shi (JP)

(21) Appl. No.: 13/366,047

(22) Filed: Feb. 3, 2012

(30) Foreign Application Priority Data
Apr. 19, 2011 (JP) 2011-093414

(51) Int. Cl. H04N 9/80

(52) U.S. Cl. 386/248; 386/E05.001

(57) ABSTRACT

According to one embodiment, a playback method includes decoding data compressed and encoded, by using a first decoder, thereby generating a first image frame, issuing a command for switching non-execution to execution, instructing a second decoder to decode the data, starting with a picture from which is generated an image frame independent of any other image frame of the data, when the command issued, decoding the data by using the second decoder, thereby generating a second image frame, inferring depth values for pixels contained in the second image frame, thereby generating a depth map, and generating left-eye and right-eye image data based on the depth map and the first image frame.

### CROSS-REFERENCE TO RELATED APPLICATIONS

This application is based upon and claims the benefit of priority from prior Japanese Patent Application No. 2011-093414, filed Apr. 19, 2011, the entire contents of which are incorporated herein by reference.

### FIELD

Embodiments described herein relate generally to a playback apparatus, a playback method, and a program, all for generating three-dimensional images from two-dimensional images.

### BACKGROUND

In recent years, various display apparatuses have been provided, which are configured to display three-dimensional images. Such an apparatus displays a left-eye image and a right-eye image, causing a viewer to perceive a three-dimensional (stereoscopic) image by virtue of binocular parallax.

Most of the video content received from the broadcasting stations or through networks contains two-dimensional images. To enable users to view three-dimensional images based on such video content, various 2D-to-3D conversion techniques have been proposed, each devised to convert two-dimensional images to three-dimensional images.

In order to generate a three-dimensional image from a two-dimensional image, depth values are inferred for some of the pixels constituting the two-dimensional image, generating a depth map. To infer these depth values, a great amount of data must be processed. The process of inferring the depth values is therefore better performed by a processor other than the CPU or the GPU. To perform the process of inferring the depth values, the video data must be decoded to generate image frames. To this end, it is desired that data compressed and encoded be transferred to a decoder connected to the processor and a memory by different buses, in order to reduce the amount of data transferred between the processor and the memory.

Since the load of processing data to infer the depth values is large, a processor other than a multimedia processor should be used to generate three-dimensional images. Also in generating three-dimensional images, image frames must be obtained by decoding the video data. To reduce the amount of data to transfer, the video data is better decoded by a decoder other than the decoder that generates image frames for use in inferring the depth values.

If one processor is used to generate image frames for use in inferring the depth values, and another processor is used to generate image frames for use in generating three-dimensional images, a two-dimensional image is not smoothing switched to a three-dimensional image in some cases. Some measures must therefore be taken to achieve smooth switching of any two-dimensional image to a three-dimensional image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an exemplary configuration of the playback apparatus according to a first embodiment.

FIG. 2 is a block diagram showing the exemplary configuration of the playback apparatus according to the first embodiment.

FIG. 3 is a block diagram showing an exemplary configuration of the multimedia processor shown in FIG. 2.

FIG. 4 is a block diagram showing an exemplary functional configuration of the video content playback program the playback apparatus according to the first embodiment executes.

FIG. 5 is a diagram showing an exemplary configuration of the control panel displayed by the control panel display module shown in FIG. 4.

FIG. 6 is a flowchart showing the sequence of processes the switching instruction issuing module shown in FIG. 4 performs.

FIG. 7 is a flowchart showing the sequence of switching a two-dimensional image to a three-dimensional image, or vice versa, in the playback apparatus according to the first embodiment.

FIG. 8 is a block diagram showing an exemplary functional configuration of the video content playback program executed by a playback apparatus according to a second embodiment.

FIG. 9 is an exemplary flowchart showing the sequence of processes the switching instruction issuing module shown in FIG. 8 performs.

FIG. 10 is a flowchart showing the sequence of switching a two-dimensional image to a three-dimensional image, or vice versa, in the playback apparatus according to the second embodiment.

### DETAILED DESCRIPTION

Various embodiments will be described hereinafter with reference to the accompanying drawings.

In general, according to one embodiment, a playback apparatus comprises a first decoder, a second decoder, a depth map generating module, a three dimensional image generating module, a command issuing module, and a switching module. The first decoder is configured to decode video data compressed and encoded, thereby generating a first image frame. The second decoder is configured to decode the video data, thereby generating a second image frame corresponding to the first image frame when a three dimensional image generation is executed. The depth map generating module is configured to generate a depth map, by inferring depth values for pixels contained in the second image frame. The three dimensional image generating module is configured to generate left eye image data and right eye image data based on the first image frame. The command issuing module is configured to issue an execution command for switching non execution of the three dimensional image generation to execution of the three dimensional image generation. The switching module is configured to instruct the second decoder to decode the video data, starting with a picture from which is generated an image frame independent of any other image frame of the video data, when the command issuing module issues the execution command.

### First Embodiment

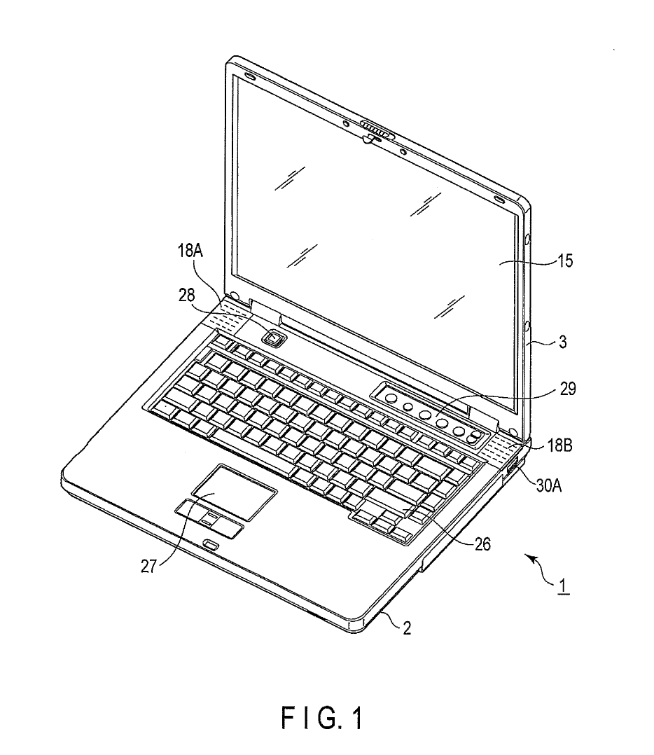

FIG. 1 is a perspective view showing the outer appearance a playback apparatus according to the first embodiment. This electronic apparatus is implemented as a notebook computer 1. Alternatively, the playback apparatus may be implemented as a television receiver, a recorder configured to store video data (e.g., a hard disk recorder), a DVD recorder, a tablet PC, a slate PC, PDA, a car navigation apparatus, or smartphone, etc.

As shown in FIG. 1, the computer 1 comprises a main module 2 and a display module 3.

The display module 3 incorporates a three-dimensional (3D) display 15. The display module 3 is secured to the main module 2 and can rotate between an opened position and a closed position. At the opened position, the display module 3 exposes the upper surface of the main module 2. At the closed position, the display module 3 covers the upper surface of the main module 2. Further, the 3D display 15 has a liquid crystal display (LCD) panel 15A and a lens module 15B. The lens module 15B is bonded to the LCD panel 15A. The lens module 15B includes a plurality of lens mechanisms configured to emit light beams in designated directions. These light beams correspond to a plurality of pixels constituting the image displayed on the LCD panel 15A. The lens module 15B is, for example, a liquid-crystal gradient index (GRIN) lens which can electrically switch the functions for displaying three dimensional images.

The 3D display 15 displays left-eye image and right-eye image in order to display a three dimensional image. This enables the user to perceive a three dimensional image.

The main module 2 is shaped like a thin box. On the upper surface of the man module 2, there are provided a keyboard 26, a power button 28, an input panel 29, a pointing device 27, two speakers 18A and 18B. If operated, the power button 28 turns on or off the computer 1. On the input panel 29, various operation buttons are arranged. These buttons includes buttons for operating TV functions (listening/viewing, recording, playback of recorded program data/video data).

A TV-program receiving antenna 30A is provided on, for example, the right side of the main module 2.

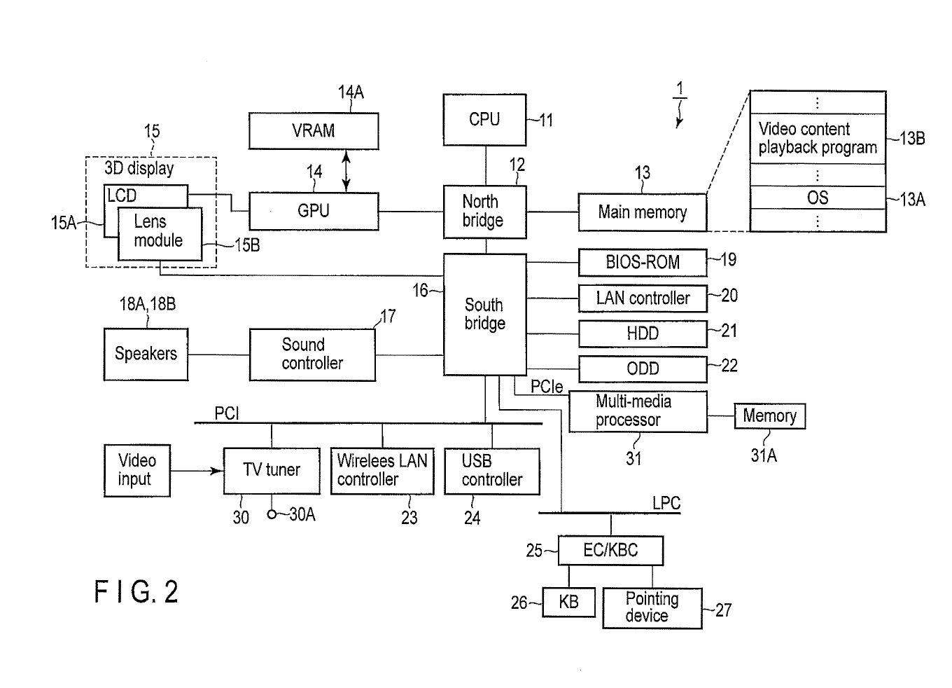

FIG. 2 is a diagram showing the system configuration of the computer 1.

As shown in FIG. 2, the computer 1 has a CPU 11, a north bridge 12, a main memory 13, a graphic processing module (GPU) 14, a video memory (VRAM) 14A, a 3D display 15, a south bridge 16, a sound controller 17, speakers 18A and 18B, a BIOS-ROM 19, a LAN controller 20, a hard disk drive (HDD) 21, a optical disk drive (ODD) 22, a wireless LAN controller 23, an USB controller 24, an embedded controller/keyboard controller (EC/KBC) 25, a keyboard (KB) 26, a pointing device 27, a TV tuner 30, a multimedia processor 31, and a memory 31A.

The CPU 11 is the processor for controlling the other components of the computer 1. The CPU 11 executes application programs such as an operating system (OS) 13A and a video content playback program 13B, which have been loaded from the HDD 21 into the main memory 13. The video content playback program 13B is software that has the functions of displaying video content data. The video content playback program 13B describes various processes, such as a live playback process for enabling the user to listen and view the program data received via the TV tuner 30, a recording process for recoding the received program data in the HDD 21, and a playback process for reproducing the program data/video data recorded in the HOD 21 or the video content data received via a network. Moreover, the video content playback program 13B can reproduce the video content data stored in a recording medium (e.g., DVD) or a storage device (e.g., hard disk).

The video content playback program 13B further has the function of enabling the user to view three-dimensional images. The video content playback program 13B converts the two-dimensional image contained in the video content data, to a three-dimensional image in real time. The three-dimensional image is displayed on the screen of the 3D display 15. The video content playback program 13B can perform 2D-to-3D conversion on various video content data items (e.g., broadcast program data, video data stored in a storage media or storage device, or video data received from any server on the Internet).

The 3D display 15 configured to display s three-dimensional image is a naked-eye stereoscopic system (e.g., integral imaging system, lenticular system, or parallax barrier system). Seeing the image displayed on the screen of the 3D display 15 of the naked-eye stereoscopic system, the user perceives a three-dimensional image with the naked eye. The naked-eye stereoscopic system may be replaced by the active shutter system or the polarizing film system, which can also make the user perceive three-dimensional images.

The CPU 11 also executes the Basic Input/Output System (BIOS) stored in the BIOS-ROM 19. The BIOS is a program for controlling the hardware.

The north bridge 12 is a bridge device configured to connect the local bus of the CPU 11 to the south bridge 16. The north bridge 12 incorporates a memory controller that controls the access to the main memory 13. The north bridge 12 also has a function of communicating with the GPU 14.

The GPU 14 is a display controller configured to control the LCD panel 15A that is used as display monitor of the computer 1. The display signal the GPU 14 has generated is supplied to the LCD panel 15A.

The GPU 14 has a plurality of operation processors, and can generate a display signal, and can also perform pixel shader by using at least some of the operation processors. The GPU 14 can execute a programmed pixel shader, too. For example, the pixel shader decodes the video data compressed and encoded by the MPEG-2 system. Further, a process is performed, generating left-eye image data and right-eye image data from the video data decoded by the pixel shader and depth map (later described).

The south bridge 16 controls the devices on a peripheral component interconnect express (PCIe) bus and a low pin count (LPC) bus. The south bridge 16 incorporates a serial Advanced Technology Attachment (ATA) controller and a memory controller configured to control the access to the BIOS-ROM 19. The south bridge 16 further has the function of perfuming communication between the sound controller 17 and the LAN controller 20.

In response to a request made by the video content playback program 13B, the south bridge 16 can output a control signal to the lens module 15B, thereby to set the lens module 15B to either a three-dimensional display mode or a two-dimensional display mode. In response to the control signal the south bridge 16 has output, the lens module 15B changes the refractive index of a part of the liquid crystal layer, whereby its operating mode is set to either a three-dimensional display mode or a two-dimensional display mode.

The sound controller 17 is a sound source device, and outputs audio data to the speakers 18A and 18B. The speakers 18A and 18B reproduce the audio data. The LAN controller 20 is a wired communication device configured to perform a wired communication that accords with, for example, the Ethernet (registered trademark) standards. The wireless LAN controller 23 is a wireless communication device configured to perform a wireless communication that accords with, for example, the IEEE 802.11 standard. The USB controller 24 is configured to communicate with an external apparatus through a cable of, for example, the USB 2.0 standard.

The multimedia processor 31 is connected to the south bridge 16 by, for example, a serial bus that accords with the PCI EXPRESS (PCIe) standard. The memory 31A is used as work memory for the multimedia processor 31.

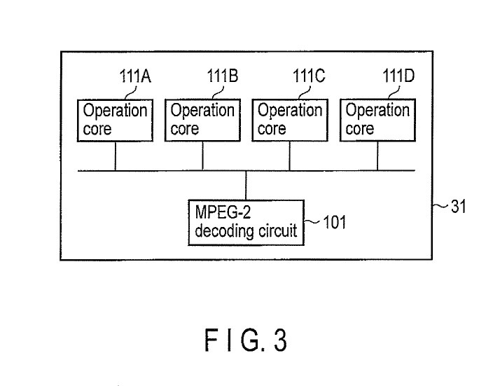

The multimedia processor 31 is an one-chip device, which incorporates, as shown in FIG. 3, an MPEG-2 decoding circuit 101 and four operation cores 111A to 111D. The MPEG-2 decoding circuit 101 is configured to decode video data compressed and encoded. Each of the operation cores 111A to 111D have high media-processing ability and excel high performance-to-power ratio. To enable the video content playback program 13B to reproduce content, the MPEG-2 decoding circuit 101 decodes the video data. The four operation cores 111A to 111D perform a process of generating a depth map for each image frame of the video data decoded by the MPEG-2 decoding circuit 101. In this embodiment, the operation cores 111A to 111D of the multimedia processor 31, which is a dedicated one unlike the CPU 11, is used as back-end processor, in the process of generating the depth map. Hence, the depth map can be generated, without increasing the load on the CPU 11.

The EC/KBC 25 is an one-chip microcomputer incorporating an embedded controller and a keyboard controller. The embedded controller is configured to perform power control. The keyboard controller is configured to control the keyboard (KB) 26 and the pointing device 27. The EC/KBC 25 has the function of turning on and off the computer 1 as the user operates it.

The TV tuner 30 is a receiving device configured to receive program data broadcast on a television (TV) signal, and is connected to the TV-program receiving antenna 30A. The TV tuner 30 is implemented as a digital TV tuner that can receive digital broadcast program data such as terrestrial digital TV program data. Further, the TV tuner 30 has the function of capture the video data coming from an external apparatus.

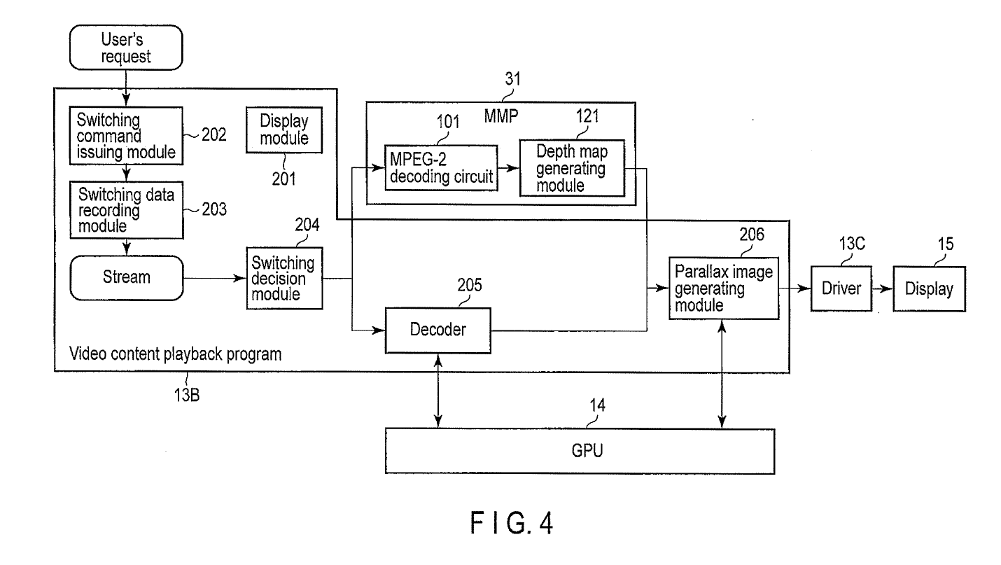

FIG. 4 shows the functional configuration of the video content playback program 13B. The video content playback program 13B has the function of generating a three-dimensional image form a two-dimensional image, and also has the function of switching a two-dimensional image to a three-dimensional image, and vice versa. In the configuration of FIG. 4, the video content playback program 13B and a display driver program 13C causes the 3D display 15 to display a three-dimensional image. Switching between the two-dimensional image and the three-dimensional image can be considered as switching between the generation of a three-dimensional image and the non-generation of a three-dimensional image.

The video content playback program 13B comprises a control panel display module 201, a switching command issuing module 202, a switching data recording module 203, a switching decision module 204, a decoder 205, and a parallax image generating module 206. The video content playback program 13B has the function of causing the multimedia processor 31 to decode the compressed and encoded video data and the function of generating a depth map. In the multimedia processor 31, the MPEG-2 decoding circuit 101 decodes the compressed and encoded video data. The multimedia processor 31 has a depth map generating module 121. The depth map generating module 121 includes the operation cores 111A to 111D, and generates a depth map.

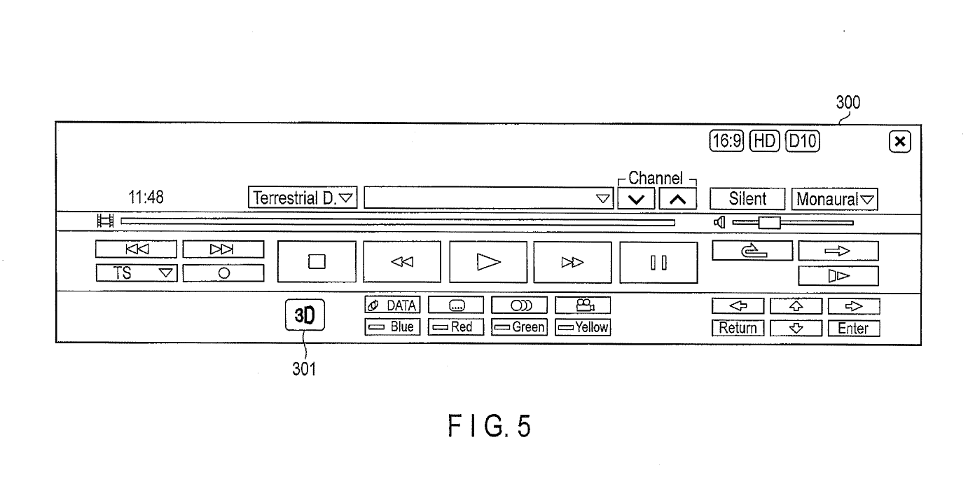

The control panel display module 201 causes the 3D display 15 to display such a control panel 300 as shown in FIG. 5. The control panel 300 has a switch button 301 which may be touched to switch a two-dimensional image to a three-dimensional image, or vice versa.

When the user touches the switch button 301 displayed on the 3D display 15, the switching command issuing module 202 issues a 2D display command (non-execution command) or a 3D display command (execution command). The 2D display command is a command for switching the 3D display to the 2D display. The 3D display command is a command for switching the 2D display to the 3D display.

In accordance with the 2D display command or the 3D display command, the switching data recording module 203 sets the discontinuation flags in packets constituting a video data stream (thus, changing the flag to discontinuous data), and records 3D display data or 2D display data in the packets.

The packets constituting the video data stream are sequentially input to the switching decision module 204. The switching decision module 204 first makes decisions and then output each packet to both the decoder 205 and the multimedia processor 31, or to at least the decoder 205.

The switching decision module 204 determines whether the discontinuation flags in the packets constituting the video data stream are set or not. If the switching decision module 204 determines that the discontinuation flags are set, it determines which data, 3D display data or 2D display data, is recorded in the packets.

If the switching decision module 204 determines that 3D display data is recorded in the packets, it outputs the video data stream to the multimedia processor 31 and decoder 205. Then, the switching decision module 204 instructs the MPEG-2 decoding circuit 101 to decode the video data, starting with an I picture from which image frames can be generated independently of any other frames.

The extensive research conducted by the inventors hereof shows that a 2D image is not smoothly switched to a 3D image if the MPEG-2 decoding circuit 101 decodes a B picture that depends on any other frames and cannot be decoded alone. In order to switch a 2D image a 3D image smoothly, the switching decision module 204 instructs the MPEG-2 decoding circuit 101 to decode the video data, starting with an I picture.

If the switching decision module 204 determines that 2D display data is recorded in the packets, it outputs the packets constituting the video data stream to only the decoder 205. The switching decision module 204 then instructs the multimedia processor 31 to output all depth map held in the memory 31A, to the parallax image generating module 206.

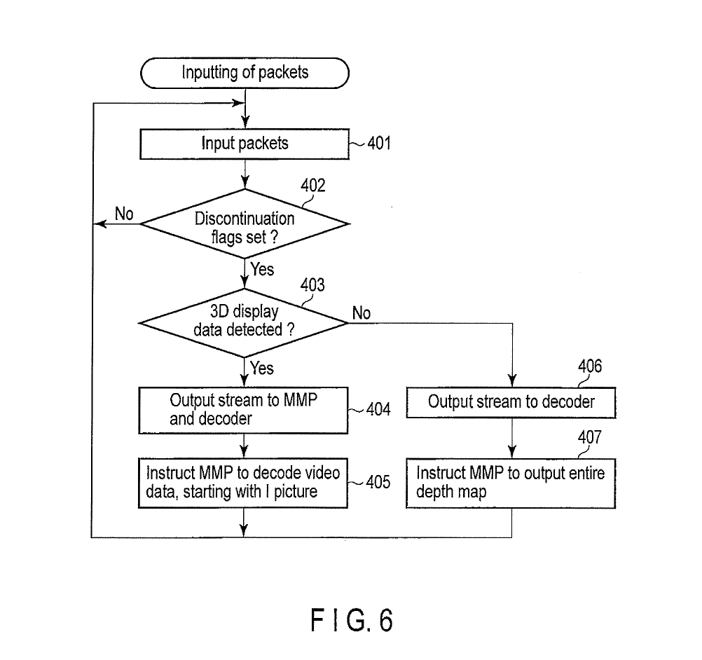

The sequence of processes the switching decision module 204 performs will be explained with reference to the flowchart of FIG. 6. On receiving the packets constituting the video data stream (Block 401), the switching decision module 204 determines whether the discontinuation flags in the packets are set or not (Block 402). If the discontinuation flags are not set (No in Block 402), the packets are output from the previous destination (Block 408). If the discontinuation flags are set (Yes in Block 402), the switching decision module 204 determines whether the 3D display data is recorded in the packet (Block 403). If the 3D display data is recorded in the packet (Yes in Block 403), the switching decision module 204 outputs the video data stream to both the decoder 205 and multimedia processor 31 (Block 404). Next, the switching decision module 204 instructs the multimedia processor 31 to decode the video data, starting with an I picture (Block 405). If the 3D display data is found not recorded (No in Block 403), the switching decision module 204 outputs the video data stream to the decoder 205 only (Block 406). The switching decision module 204 then instructs the multimedia processor 31 to output the entire depth map stored in the memory 31A, to the parallax image generating module 206 (Block 407).

The decoder 205 decodes the video data by using the decoding support function of the GPU 14, thereby generating a plurality of image frame data items.

In order to display a three-dimensional image, the multimedia processor 31 uses the decoding circuit 101, decoding the I picture and thereby generating video data, and generate a plurality of image frames. The depth map generating module 121 incorporated in the multimedia processor 31 generates a depth map, which will be later described.

The depth map generating module 121 uses the image frame (i.e., source 2D frame) to be processed, inferring the depth values (depth positions) for the pixels contained in the image frames. Thus, the depth map generating module 121 generates a depth map. The depth map contains a plurality of depth values associated with the respective pixels included in the image frame that will be processed. The depth values are, for example, integer values from −127 to 128. The depth map thus generated is stored in the buffer area of the memory 31A. In most cases, the depth map for any image frame used as a reference image frame for any image frame delayed because of depth inferring is never output before the next image frame is input.

The depth map generating module 121 uses various methods, inferring depth values for the pixels included in the image frame, and divides the image frame into a plurality of regions. Further, the depth map generating module 121 determines which region exists in front of any other (that is, whether each region is background or foreground with respect to any other region), thereby finding the depth values for the pixels. Moreover, the depth map generating module 121 infers the depth values of pixels, based on the fact an object moves faster than any other in the background. The depth map generating module 121 detects the position of a person's face in each image frame and allocates depth values to the parts of the face, using the face position as reference, thereby inferring the depth values for the pixels.

The depth map generating module 121 outputs the depth map to the parallax image generating module 206. The parallax image generating module 206 calculates parallax from the depth map, generating a parallax map. The parallax map contains different parallaxes associated with the depth values, respectively.

To display a three-dimensional image, the parallax image generating module 206 uses the parallax map and the image frames represented by the image frame data generated by the decoder 205, thereby generating three-dimensional video data that includes left-eye image data and right-eye image data. The three-dimensional video data is supplied to the 3D display 15, which displays a three-dimensional image. The parallax image generating module 206 uses some of the operation processors provided in the CPU 14, generating three-dimensional video data.

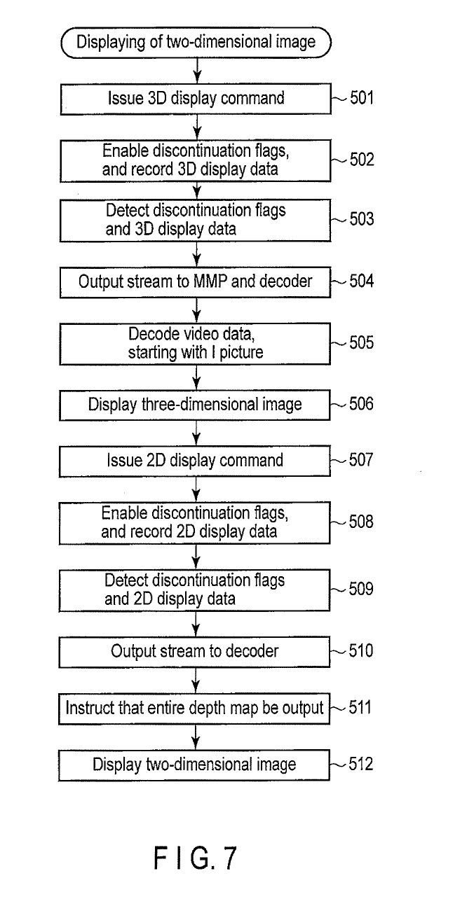

The sequence of switching a two-dimensional image to a three-dimensional image, or vice versa, will be explained with reference to the flowchart of FIG. 7.

Assume that the user touches the switch button 301 while the 3D display 15 is displaying a two-dimensional image. Then, the switching command issuing module 202 issues a 3D display command (Block 501). In response to the 3D display command, the switching data recording module 203 sets the discontinuation flags in the packets constituting a video data stream, and records 3D display data in the header (Block 502). The switching decision module 204 detects any packet in which the discontinuation flag is set, and then determines whether 3D display data is recorded in the packet. The switching decision module 204 then determines that 3D display data is recorded (Block 503). The switching decision module 204 outputs the video data stream to both the decoder 205 and multimedia processor 31 (Block 504). The switching decision module 204 instructs the multimedia processor 31 to decode the video data, starting with an I picture (Block 505). In the multimedia processor 31, the MPEG-2 decoding circuit 101 decodes the video data stream, starting with an I picture. As a result, a plurality of image frames are generated. The depth map generating module 121 generates a depth map for the image frames. The parallax image generating module 206 generates three-dimensional video data from the depth map and the image frames generated by the decoder 205, whereby the 3D display 15 displays the three-dimensional image (Block 506).

Assume that the user touches the switch button 301 while the 3D display 15 is displaying a three-dimensional image. Then, the switching command issuing module 202 issues a 2D display command (Block 507). In response to the 2D display command, the switching data recording module 203 sets the discontinuation flags in the packets constituting a video data stream, and records 2D display data in the header (Block 508). When any packet in which the discontinuation flag is set is detected, the switching decision module 204 determines whether 3D display data is recorded the packet. The switching decision module 204 determines that the 3D display data is not recorded, but the 2D display data is recorded (Block 509). The switching decision module 204 outputs the video data stream to the decoder 205 only (Block 510). The switching decision module 204 then instructs the multimedia processor 31 to output the entire depth map stored in the memory 31A, to the parallax image generating module 206 (Block 511). The parallax image generating module 206 generates three-dimensional video data by using the entire depth map, and then outputs the image frames generated by the decoder 205, without processing the image frames, whereby the 3D display 15 displays the three-dimensional image (Block 512).

As described above, the switching decision module 204 instructs the MPEG-2 decoding circuit 101 to decode the video data stream, starting with the I picture. This can smoothly switch the display of a three-dimensional image to the display of a two-dimensional image.

### Second Embodiment

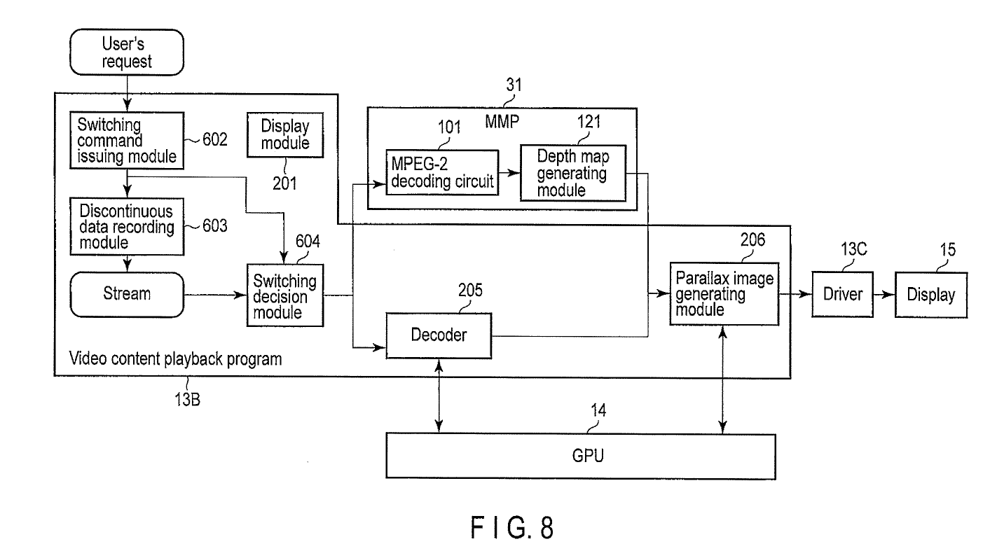

FIG. 8 is a block diagram showing the functional configuration of the video content playback program 13B, which differs from the configuration according to the first embodiment.

As shown in FIG. 8, the video content playback program 13B comprises a control panel display module 601, a switching command issuing module 602, a discontinuous data recording module 603, a switching decision module 604, a decoder 205, and a parallax image generating module 206.

When the user touches the switch button 301 displayed on the 3D display 15, the switching command issuing module 602 issues a 2D display command or a 3D display command to the switching decision module 604.

In accordance with the 2D display command or the 3D display command, the switching data recording module 603 sets the discontinuation flags in packets constituting a video data stream.

The packets constituting the video data stream are sequentially input to the switching decision module 604. The switching decision module 604 first makes decisions and then output each packet to both the decoder 205 and the multimedia processor 31, or to at least the decoder 205.

The switching decision module 604 determines whether the discontinuation flags in the packets constituting the video data stream are set or not. If the switching decision module 604 determines that the discontinuation flags are set, it determines which command, 3D display command or 2D display command, the switching command issuing module 602 has issued.

If the switching decision module 604 determines that the 3D display command has been issued, it outputs the packets constituting the video data stream to both the multimedia processor 31 and the decoder 205, and instructs the multimedia processor 31 to decode the video data, starting with an I picture.

If the switching decision module 604 determines that the 2D display command has been issued, it outputs the packets constituting the video data stream to the decoder 205 only. The switching decision module 604 then instructs the multimedia processor 31 to output the entire depth map stored in the memory 31A, to the parallax image generating module 206.

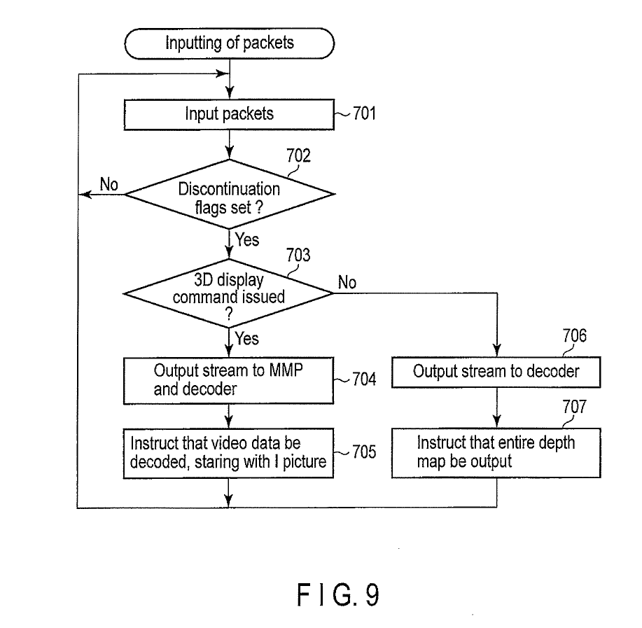

The sequence of processes the switching decision module 604 performs will be explained with reference to the flowchart of FIG. 9. On receiving the packets constituting the video data stream (Block 701), the switching decision module 604 determines whether the discontinuation flags in the packets are set or not (Block 702). If the discontinuation flags are not set (No in Block 702), the packets are input to the previous destination. If the discontinuation flags are set (Yes in Block 702), the switching decision module 704 determines whether the switching command issuing module 602 has issued a 3D display command (Block 403). If the 3D display command has been issued (Yes in Block 703), the switching decision module 604 outputs the video data stream to both the decoder 205 and multimedia processor 31 (Block 704). Next, the switching decision module 604 instructs the multimedia processor 31 to decode the video data, starting with an I picture (Block 705). If the 3D display command is found not issued (No in Block 703), the switching decision module 204 outputs the video data stream to the decoder 205 only (Block 706). The switching decision module 604 then instructs the multimedia processor 31 to output the entire depth map stored in the memory 31A, to the parallax image generating module 206 (Block 707).

The decoder 205, depth map generating module 121 and parallax image generating module 206 have the same functions as those of their counterparts used in the first embodiment, and will not be described.

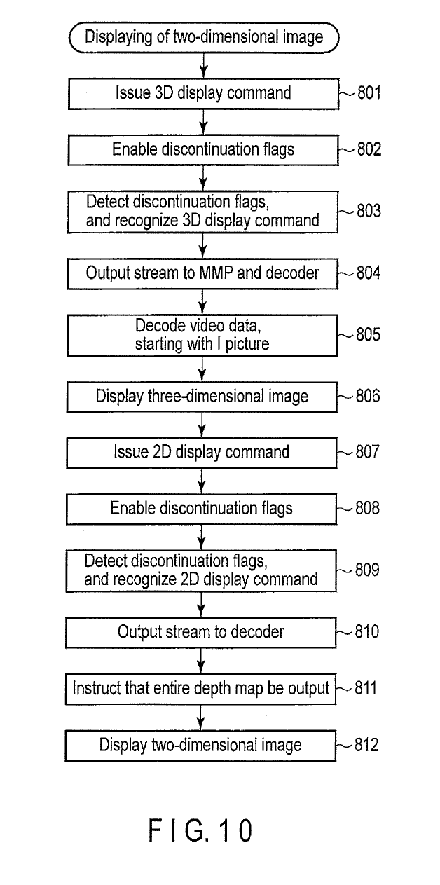

The sequence of switching a two-dimensional image to a three-dimensional image, or vice versa, will be explained with reference to the flowchart of FIG. 10.

Assume that the user touches the switch button 301 while the 3D display 15 is displaying a two-dimensional image. Then, the switching command issuing module 602 issues a 3D display command (Block 801). In response to the 3D display command, the switching data recording module 603 sets the discontinuation flags in the packets constituting a video data stream (Block 802). The switching decision module 604 detects any packet in which the discontinuation flag is set, and then determines whether the command output from the switching decision module 602 is a 3D display command or not. The switching decision module 604 determines that 3D display command has been issued (Block 803). The switching decision module 604 outputs the video data stream to both the decoder 205 and multimedia processor 31 (Block 804). The switching decision module 604 instructs the multimedia processor 31 to decode the video data, starting with an I picture (Block 805). In the multimedia processor 31, the MPEG-2 decoding circuit 101 decodes the video data stream, starting with an I picture. As a result, a plurality of image frames are generated. The depth map generating module 121 generates a depth map for the image frames. The parallax image generating module 206 generates three-dimensional video data from the depth map and the image frames generated by the decoder 205, whereby the 3D display 15 displays the three-dimensional image (Block 806).

Assume that the user touches the switch button 301 while the 3D display 15 is displaying a three-dimensional image. Then, the switching command issuing module 202 issues a 2D display command (Block 807). In response to the 2D display command, the switching data recording module 603 sets the discontinuation flags in the packets constituting a video data stream, and records 2D display data in the header (Block 808). When any packet in which the discontinuation flag is set is detected, the switching decision module 604 determines whether the command output from the switching decision module 602 is a 3D display command or not. Assume that the switching decision module 604 determines that the 3D display command has not been issued, or that a 2D display command has been issued (Block 809). Then, the video data stream is output to the decoder 205 only (Block 810). The switching decision module 604 then instructs the multimedia processor 31 to output the entire depth map stored in the memory 31A, to the parallax image generating module 206 (Block 811). The parallax image generating module 206 generates three-dimensional video data by using the entire depth map, and then outputs the image frames generated by the decoder 205, without processing the image frames, whereby the 3D display 15 displays the three-dimensional image (Block 812).

As described above, the switching decision module 602 issues a display command to the switching decision module 604, and the switching decision module 604 instructs the MPEG-2 decoding circuit 101 to decode the video data stream, starting with an I picture. This can smoothly switch the display of a two-dimensional image to the display of a three-dimensional image.

The sequence of reproducing video data can be implemented as software in the embodiments described above. Hence, if the software is installed in a computer of ordinary type via a computer-readable storage medium storing the software, the same advantage as achieved in the embodiments will be easily attained.

In the embodiments described above, the video data is data compressed and encoded by the MPEG-2 system. Nonetheless, the processes described above can be performed on video data compressed and encoded by any other system such as MPEG-1, MPEG-4, H.264/MPEG-4, AVC, VC-1 or DivX.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A playback apparatus comprising:
a first decoder configured to decode video data compressed and encoded, thereby generating a first image frame;
a second decoder configured to decode the video data, thereby generating a second image frame corresponding to the first image frame when a three-dimensional image generation is executed;
a depth map generating module configured to generate a depth map, by inferring depth values for pixels contained in the second image frame;
a three-dimensional image generating module configured to generate left-eye image data and right-eye image data based on the first image frame;
a command issuing module configured to issue an execution command for switching non-execution of the three-dimensional image generation to execution of the three-dimensional image generation; and
a switching module configured to instruct the second decoder to decode the video data, starting with a picture from which is generated an image frame independent of any other image frame of the video data, when the command issuing module issues the execution command.

2. The apparatus of claim 1, wherein the command issuing module is configured to issue a non-execution command for switching the execution of the three-dimensional image generation to the non-execution of the three-dimensional image generation, and
the switching module is configured to instruct the depth map generating module to output the depth map to the three-dimensional image generating module, when the command issuing module issues the non-execution command.

3. The apparatus of claim 2, further comprising a recording module configured to record discontinuation data and execution data in packets constituting the video data, when the command issuing module issues the execution command, and to record the discontinuation data and non-execution data in the packets constituting the video data, when command issuing module issues the non-execution command,
wherein the switching module is configured to determine whether the discontinuation data is recorded in the packets,
to determine which of data the execution data and the non-execution data, is recorded in the packets when the discontinuation data is recorded in the packets,
to instruct the second decoder to decode the video data, starting with a picture from which to generate an image frame independent of any other image frame of the video data, when the discontinuation data is recorded in the packets, and
to instruct the depth map generating module to output the depth map to the three-dimensional image generating module, when the non-execution data is found recorded in the packets.

4. The apparatus of claim 2, further comprising a discontinuation data recording module configured to record discontinuation data in packets constituting the video data, when the command issuing module issues the execution command or the non-execution command,
wherein the switching module is configured to determine which of the execution command and the non-execution command the command issuing module has issued, when the discontinuous data recorded in the packets are detected,
to instruct the second decoder to decode the video data, starting with the picture from which is generated the image frame independent of any other image frame of the video data, if the command issuing module is found to have issued the execution command, and
to instruct the depth map generating module to output the depth map inferred by the depth map generating module to the three-dimensional image generating module, when it is determined that the command issuing module issued the non-execution data.

5. The apparatus of claim 1, further comprising operation processors that are used as the second decoder and the depth map generating module.

6. The apparatus of claim 1, further comprising a graphic processing module configured to generate a video signal to be displayed by a display device, the graphic processing module functioning as the first decoder and the three-dimensional image generating module.

7. The apparatus of claim 1, wherein the map generating module is configured to use depth inferring methods, thereby inferring the depth values.

8. A playback method comprising:
decoding video data compressed and encoded, by using a first decoder, thereby generating a first image frame;
issuing an execution command for switching non-execution of three-dimensional image generation to execution of the three-dimensional image generation;
instructing a second decoder to decode the video data, starting with a picture from which is generated an image frame independent of any other image frame of the video data, when the execution command is issued;
decoding the video data by using the second decoder, thereby generating a second image frame corresponding to the first image frame;
inferring, by using a depth map generating module, depth values for pixels contained in the second image frame, thereby generating a depth map; and
generating left-eye image data and right-eye image data based on the depth map and the first image frame, by using a three-dimensional image generating module.

9. The method of claim 8, wherein a non-execution command is issued for switching the execution of the three-dimensional image generation to the non-execution of the three-dimensional image generation, and the depth map generating module is instructed to output the depth map to the three-dimensional image generating module, when the non-execution command is issued.

10. A computer-readable, non-transitory storage medium having stored thereon a computer program which is executable by a computer, the computer program controlling the computer to execute functions of:
causing a first decoder to decode a video data, thereby generating a first image frame;
issuing an execution command for switching non-execution of three-dimensional image generation to execution of the three-dimensional image generation;
instructing a second decoder to decode the video data, starting with a picture from which is generated an image frame independent of any other image frame of the video data, when the execution command is issued;
causing the second decoder to decode the video data, thereby generating a second image frame corresponding to the first image frame;
causing a depth map generating module to infer depth values for pixels contained in the second image frame, thereby generating a depth map; and
causing a three-dimensional image generating module to generate left-eye image data and right-eye image data based on the depth map and the first image frame.

11. The medium of claim 10, wherein the computer program controls the computer to further execute functions of:
switching the execution of the three-dimensional image generation to the non-execution of the three-dimensional image generation; and
instructing the depth map generating module to output a depth map inferred by the depth map generating means, to the three-dimensional image generating means, when the non-execution command is issued.
